(19) United States
(12) Patent Application Publication
(10) Pub. No.: US 2005/0037819 A1
(43) Pub. Date: Feb. 17, 2005

(54) Cellular telephone with automatic turn on and off function

(76) Inventor: Adir Naor, Bat Yam (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 10/912,120

(22) Filed: Aug. 6, 2004

Related U.S. Application Data
(60) Provisional application No. 60/493,791, filed on Aug. 11, 2003.

(51) Int. Cl. H04B 1/00

(52) U.S. Cl. 455/574; 455/575.3

(57) ABSTRACT

A. method for operating a mobile communication device including providing a mobile communication device with an “automatic turn on and off function” mode, which automatically turns off the mobile communication device for a first period of time and automatically turns on the mobile communication device for a second period of time. The first and second periods of time may be changed or modified by the user, such as by pressing appropriate buttons.

### FIELD OF THE INVENTION

This invention relates generally to cellular telephone communication and communication devices.

### BACKGROUND OF THE INVENTION

Cellular telephone communication devices are provided with many kinds of functions and function keys. Some cellular telephone communication devices are provided with a so-called “sleep” function wherein the cell phone powers down if not used for a while and powers up afterwards when in use, such as by touching the keypad.

### SUMMARY OF THE INVENTION

The present invention seeks to provide a mobile communication device with an automatic turn on and off function, as is described in detail further hereinbelow.

There is provided in accordance with an embodiment of the present invention a method for operating a mobile communication device including providing a mobile communication device with an “automatic turn on and off function” mode, which automatically turns off the mobile communication device for a first period of time and automatically turns on the mobile communication device for a second period of time. The first and second periods of time may be changed or modified by the user, such as by pressing appropriate buttons.

The method may include using a password to enable or disable the “automatic turn on and off function” mode. Different possibilities of the “automatic turn on and off function” mode may be displayed on a display of the mobile communication device.

The “automatic turn on and off function” mode may include an every day mode, wherein the mobile communication device is automatically disabled for a period of time every day.

The “automatic turn on and off function” mode may include a temporary mode, wherein the mobile communication device is automatically disabled for a temporary period of time.

There is also provided in accordance with an embodiment of the present invention apparatus including a mobile communication device with an “automatic turn on and off function” mode, which automatically turns off the mobile communication device for a first period of time and automatically turns on the mobile communication device for a second period of time.

### BRIEF DESCRIPTION OF THE DRAWINGS

The present invention will be understood and appreciated more fully from the following detailed description taken in conjunction with the drawings in which:

FIG. 1 is a simplified illustration of a mobile communication device, constructed and operative in accordance with an embodiment of the present invention; and

FIG. 2 is a simplified illustration of a display of the mobile communication device showing an automatic turn on and off function, in accordance with an embodiment of the present invention.

### DETAILED DESCRIPTION OF EMBODIMENTS

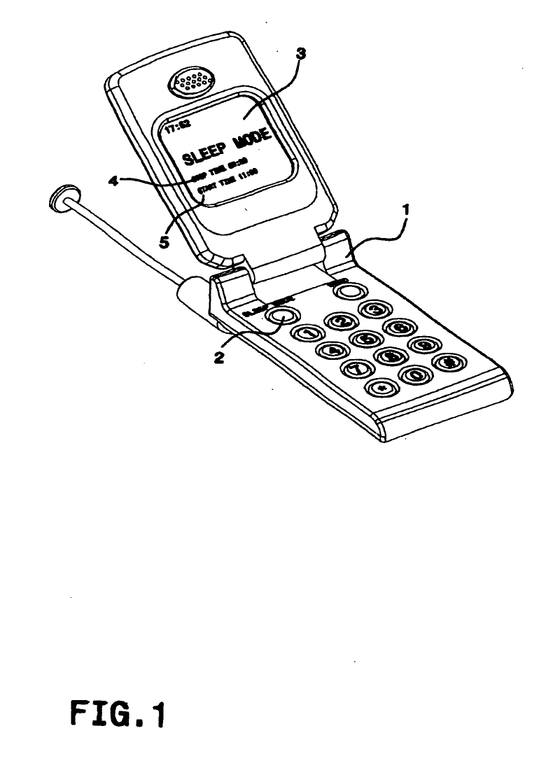

Reference is now made to FIG. 1, which illustrates a mobile communication device 1, constructed and operative in accordance with an embodiment of the present invention. The term “mobile communication device” encompasses any kind of mobile communication device, such as but not limited to, a pager, a walkie-talkie, or a cell phone (also called cellular telephone), the terms being used interchangeably throughout for the sake of simplicity.

Mobile communication device 1 may include the usual functions, components and buttons of the familiar cell phone. In accordance with an embodiment of the present invention, mobile communication device 1 may include a sleep mode button 2, which when pressed places the device 1 into sleep mode (as shown on a display 3).

In the present invention, the term “sleep mode” is not the same and should not be confused with the “sleep” function of prior art cell phones, wherein the cell phone powers down if not used for a while and powers up afterwards when in use. Rather in the present invention, the term “sleep mode” refers more accurately to an “automatic turn on and off function” mode, which may be used when a user of mobile communication device 1 is interested in going to sleep or does not want to be disturbed for a certain period of time. Accordingly the sleep mode button is also referred to herein as the “automatic turn on and off function” mode press button.

“Automatic turn on and off function” mode enables the user to screen or block phone calls at hours that are not convenient to the user. When the user is willing to receive the calls, he has a possibility of taking out the calls recorded in its voice call box. “Automatic turn on and off function” mode also enables a person, for example, to prevent abuse of the cell phone by not permitting its use for a period of time. A password may be used to enable or disable such a mode of operation.

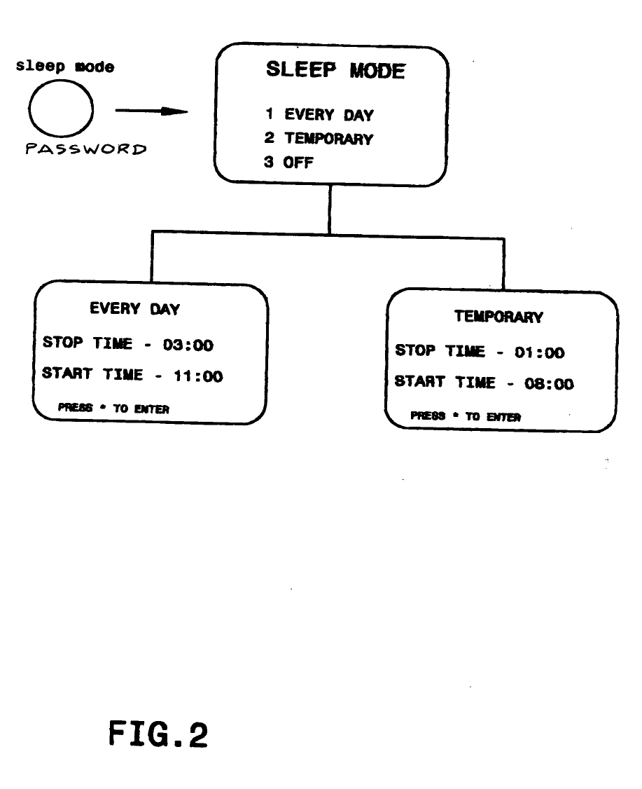

When the “automatic turn on and off function” mode press button is pressed, a window may appear in display 3 that shows different possibilities of “automatic turn on and off function” mode, as seen in FIG. 2.

Non-limiting examples of possibilities are:
Every day
Temporary
Off

The user may choose the most suitable possibility for him/her.

For example:

1. Every day—mode of fixed time wherein the cell phone is automatically disabled between certain hours. The disablement may be carried out every day during subsequent days of the week, or for any other period of time.

2. Temporary—the cell phone is disabled temporarily for some period of time set by the user. This mode will not be carried out for a fixed period of time over several days, rather for a transient period of time.

3. Off—mode of nonuse in “automatic turn on and off function” mode.

In the Every day mode, the user may activate a window to change the hours of Stop time (reference numeral 4 in FIG. 1) and Start Time (reference numeral 5 in FIG. 1).

Stop Time—setting mode for determining the automatic turn off time.

Start Time—setting mode for determining the automatic activation (turn on) time that is carried out at a predetermined time.

For example, in every day or temporary mode, a window may prompt the user to press certain keys, such as a written notice that states “Press * to Enter”, whereupon the user may enter the desired information (starting times, stop times, confirmation of input data, delete, modify and the like).

It is appreciated that various features of the invention which are, for clarity, described in the contexts of separate embodiments, may also be provided in combination in a single embodiment. Conversely, various features of the invention which are, for brevity, described in the context of a single embodiment, may also be provided separately or in any suitable subcombination.

1. A method for operating a mobile communication device comprising:
providing a mobile communication device with an “automatic turn on and off function” mode, which automatically turns off the mobile communication device for a first period of time and automatically turns on the mobile communication device for a second period of time.

2. The method according to claim 1, comprising using a password to enable or disable the “automatic turn on and off function” mode.

3. The method according to claim 1, comprising displaying different possibilities of the “automatic turn on and off function” mode on a display of the mobile communication device.

4. The method according to claim 1, wherein the “automatic turn on and off function” mode comprises an every day mode, wherein the mobile communication device is automatically disabled for a period of time every day.

5. The method according to claim 1, wherein the “automatic turn on and off function” mode comprises a temporary mode, wherein the mobile communication device is automatically disabled for a temporary period of time.

6. The method according to claim 1, further comprising changing at least one of the first and second periods of time.

7. Apparatus comprising:
a mobile communication device with an “automatic turn on and off function” mode, which automatically turns off the mobile communication device for a first period of time and automatically turns on the mobile communication device for a second period of time.
